(19) United States
(12) Patent Application Publication
(10) Pub. No.: US 2026/0106477 A1
(43) Pub. Date: Apr. 16, 2026

(54) METHOD OF RESETTING STATE OF CHARGE IN SECONDARY BATTERY CHARGE/DISCHARGE TEST

(71) Applicant: SK ON CO., LTD., Seoul (KR)

(72) Inventor: Chang Mook HWANG, Daejeon (KR)

(21) Appl. No.: 19/344,436

(22) Filed: Sep. 29, 2025

(30) Foreign Application Priority Data
Oct. 16, 2024 (KR) 10-2024-0141112

(51) Int. Cl. H02J 7/00

(52) U.S. Cl. CPC H02J 7/82; H02J 7/933

(57) ABSTRACT

A method of resetting a state of charge (SoC) in a secondary battery charge/discharge test includes connecting a test power storage device and an auxiliary power storage device in a secondary battery charge/discharge test to control charge/discharge, checking whether the test power storage device is completed, measuring the SoC and a depth of discharge (DoD) of the auxiliary power storage device to calculate an expected lifespan, and resetting a start SoC of the auxiliary power storage device based thereon.

### CROSS REFERENCE TO RELATED APPLICATIONS

This application claims priority under 35 U.S.C. § 119 to Korean Patent Application No. 10-2024-0141112, filed on Oct. 16, 2024, in the Korean Intellectual Property Office, the disclosure of which is incorporated herein by reference in its entirety.

### TECHNICAL FIELD

The following disclosure relates to a method of resetting a state of charge in a secondary battery charge/discharge test.

### BACKGROUND

With increasing interest in eco-friendly energy, demand for secondary batteries, which may reduce the use of fossil fuels, has increased. Secondary batteries have the advantage of reducing the use of fossil fuels and improving energy efficiency through repeated use.

Secondary batteries are charged and used using a separate power supply. Secondary batteries supply stored electrical energy to an external source through discharge. Charge/discharge tests are essential during the development phase to improve secondary battery performance.

In a secondary battery charge/discharge test, in a discharge test, power stored in the secondary battery is completely discharged. In general, the discharged power is discarded. Also, in a charge test, power is supplied from an external power grid to recharge the secondary battery.

### SUMMARY

An exemplary embodiment of the present disclosure is directed to providing a method of resetting a state of charge in a secondary battery charge/discharge test, capable of efficiently performing a secondary battery charge/discharge test by resetting a state of charge of an auxiliary power storage device connected to a test power storage device in a secondary battery charge/discharge test.

In one general aspect, a method of resetting a state of charge (SoC) in a secondary battery charge/discharge test, as a method of resetting an SoC of an auxiliary power storage device in a secondary battery charge/discharge test, in which a test power storage device including a plurality of test secondary batteries is connected to a separate auxiliary power storage device and a controller controls charging and discharging of the test power storage device and the auxiliary power storage device to perform a charge/discharge test of the test power storage device, includes: checking whether the charge/discharge test of the test power storage device has been completed; checking SoC information of the auxiliary power storage device in a no-load state unconnected to the test power storage device, when the charge/discharge test has been completed; checking a depth of discharge (DoD) of the auxiliary power storage device; calculating an expected lifespan of the auxiliary power storage device based on the SoC information and the DoD; and resetting a start SoC of the auxiliary power storage device based on the calculated expected lifespan.

In the checking of the SoC information of the auxiliary power storage device, the SoC information may be an SoC range of the auxiliary power storage device.

The SoC range may be between 15% and 100% but is divided by set intervals.

In the checking of the DoD, the DoD may have a range of 50% or less or more than 50% and 80% or less.

In the resetting of the start SoC of the auxiliary power storage device, the start SoC of the auxiliary power storage device may be reset to a maximum expected lifespan in the calculated expected lifespan.

When the SoC of the test power storage device is a fully charged state before the charge/discharge test, the controller may externally transfer power of the test power storage device.

In another general aspect, a method of resetting a state of charge (SoC) in a secondary battery charge/discharge test, as a method of resetting an SoC of an auxiliary power storage device in a secondary battery charge/discharge test, in which a test power storage device including a plurality of test secondary batteries is connected to a separate auxiliary power storage device and a controller controls charging and discharging of the test power storage device and the auxiliary power storage device to perform a charge/discharge test of the test power storage device includes: checking whether the charge/discharge test of the test power storage device has been completed; checking SoC information of the auxiliary power storage device in a state of being connected to the test power storage device when the charge/discharge test has not been completed; checking a depth of discharge (DoD) of the auxiliary power storage device; and resetting a start SoC of the auxiliary power storage device based on the DoD.

In the checking of the DoD of the auxiliary power storage device, the DoD may have a range of 40% or less or more than 40% and 100% or less.

In the resetting of the start SoC of the auxiliary power storage device, the start SoC of the auxiliary power storage device may be reset based on the range of the DoD.

When the SoC of the test power storage device is a fully charged state before the charge/discharge test, the controller may externally transfer power of the test power storage device.

Other features and aspects will be apparent from the following detailed description, the drawings, and the claims.

### BRIEF DESCRIPTION OF THE DRAWINGS

FIG. 1 is a diagram schematically illustrating a secondary battery charge/discharge test system.

FIG. 2 is a flowchart illustrating a method of resetting a state of charge when a charge/discharge test is completed in a secondary battery charge/discharge test according to an exemplary embodiment.

FIG. 3 is a flowchart illustrating a method of resetting a state of charge when a charge/discharge test has not been completed in a secondary battery charge/discharge test according to an exemplary embodiment.

### DETAILED DESCRIPTION OF EXEMPLARY EMBODIMENTS

Hereinafter, the present disclosure will be described in detail with reference to the accompanying drawings. However, these are merely examples and the present disclosure is not limited to the specific exemplary embodiments described by way of example.

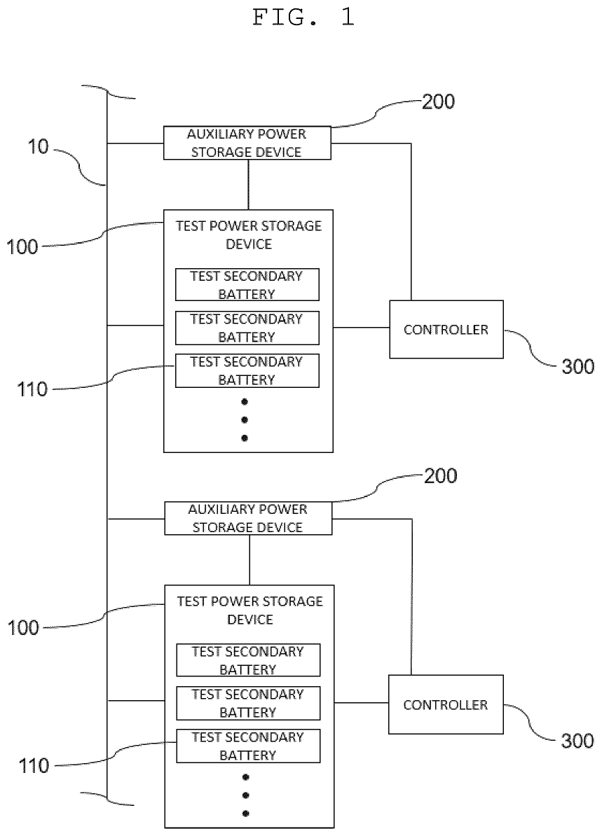

FIG. 1 illustrates a system for charging and discharging a secondary battery by connecting an auxiliary power storage device 200 to a test power storage device 100.

The system for charging and discharging a secondary battery includes the test power storage device 100, the auxiliary power storage device 200, and a controller 300.

The test power storage device 100 includes a plurality of test secondary batteries 110. The test secondary batteries 110 may include rechargeable lithium-ion batteries, lithium polymer batteries, nickel-cadmium batteries, nickel-hydrogen batteries, or nickel-zinc batteries, and their types are not particularly limited.

The test power storage device 100 includes a plurality of test secondary batteries 110 and charges or discharges the plurality of test secondary batteries 110 collectively or individually.

The auxiliary power storage device 200 is separately connected to the test power storage device 100 for a charge/discharge test of the test power storage device 100. The auxiliary power storage device 200 is configured as a rechargeable secondary battery.

The auxiliary power storage device 200 discharges stored power to charge the test power storage device 100 or is charged with power discharged by the test power storage device 100. During a charge test of the test power storage device 100, the auxiliary power storage device 200 discharges power to the test power storage device 100, and during a discharge test of the test power storage device 100, the auxiliary power storage device 200 is charged with the stored power of the test power storage device 100.

The auxiliary power storage device 200 may recycle power of the test power storage device 100, rather than discarding the power, during the discharge test.

The test power storage device 100 and the auxiliary power storage device 200 are also connected to an external power grid 10. The external power grid 10 may supplement power loss due to charge/discharge of the test power storage device 100 and the auxiliary power storage device 200.

The controller 300 controls the charging and discharging of the test power storage device 100 and the auxiliary power storage device 200. During a charge test of the test power storage device 100, the controller 300 transfers a discharge signal to the auxiliary power storage device 200, so that the auxiliary power storage device 200 charges the test power storage device 100. During a discharge test of the test power storage device 100, the controller 300 transfers a discharge signal to the test power storage device 100, so that the test power storage device 100 charges the auxiliary power storage device 200.

The controller 300 controls the charging or discharging of the auxiliary power storage device 200 and the test power storage device 100 based on a state of charge (SoC) or cut-off voltage of the auxiliary power storage device 200.

The SOC is a value representing a charged power capacity of the secondary battery as a total capacity relative to the current power capacity. The SOC is generally expressed as a percentage (%), with 0% representing a complete discharge and 100% representing a complete charge. A discharge cut-off voltage is intended to prevent overdischarging of the secondary battery, while a charge cut-off voltage is intended to prevent overcharging of the secondary battery.

The auxiliary power storage device 200 and the test power storage device 100 include a battery management system (BMS)(not shown). The BMS monitors a state of the secondary battery of the auxiliary power storage device 200 and the test power storage device 100 and transmits information on the SoC or cut-off voltage to the controller 300.

If the SoC of the auxiliary power storage device 200 falls below a set value, the controller 300 suspends the discharge of the auxiliary power storage device 200 and charges the auxiliary power storage device 200 with power from the external power grid 10.

The controller 300 receives the SoC of the auxiliary power storage device 200 through the BMS of the auxiliary power storage device 200.

If the SoC of the auxiliary power storage device 200 falls below the set value, the controller 300 suspends the auxiliary power storage device 200 from charging the test power storage device 100 through discharging. The controller 300 charges the auxiliary power storage device 200 to a value equal to or higher than the SoC set value via the external power grid 10. The SOC set value of the auxiliary power storage device 200 is preferably 80%.

If the SOC of the auxiliary power storage device 200 is equal to or greater than the set value, the controller 300 charges the test power storage device 100 by discharging the auxiliary power storage device 200.

If the SOC of the auxiliary power storage device 200 is equal to or greater than the set value, the controller 300 transmits a discharge signal to the auxiliary power storage device 200 to conduct a charge test of the test power storage device 100, so that the auxiliary power storage device 200 charges the test power storage device 100.

When the auxiliary power storage device 200 reaches a preset discharge cut-off voltage, the controller 300 stops discharging the auxiliary power storage device 200 and discharges the test power storage device 100 to charge the auxiliary power storage device 200. Here, it is preferable to set the discharge cut-off voltage to 2.5 V.

At this time, the controller 300 charges the test power storage device 100 using power from the external power grid 10 to a preset charge cut-off voltage of the test power storage device 100, and then discharges the test power storage device 100 to charge the auxiliary power storage device 200.

The controller 300 monitors the charge cut-off voltage of the test power storage device 100 to enable a discharge test of the test power storage device 100. When the test power storage device 100 is not at the charge cut-off voltage level of the test power storage device 100, the controller 300 charges insufficient power using the external power grid 10.

If the SoC of the auxiliary power storage device 200 is equal to or greater than the SoC set value but below a full SoC, the controller 300 discharges the test power storage device 100 to charge the auxiliary power storage device 200.

If the SoC of the auxiliary power storage device 200 is between the SoC set value and a fully charged state, the controller 300 controls a charge test to discharge the test power storage device 100 and charge the auxiliary power storage device 200.

If the SoC of the auxiliary power storage device 200 is a fully charged state, the controller 300 discharges the remaining power of the test power storage device 100 by bypassing the auxiliary power storage device 200. In this case, the controller 100 stops the charge/discharge test of the test power storage device 100, which is performed while the auxiliary power storage device 200 and the test power storage device 100 exchange power.

If the auxiliary power storage device 200 does not reach the preset discharge cut-off voltage but the auxiliary power storage device 200 is not fully discharged, the controller 300 stops discharging the auxiliary power storage device 200 and discharges the test power storage device 100 to charge the auxiliary power storage device 200.

Furthermore, if the auxiliary power storage device 200 does not reach the preset discharge cut-off voltage but the auxiliary power storage device 200 is fully discharged, the controller 300 stops charging and discharging the auxiliary power storage device 200 and the test power storage device 100. In this case, the controller 300 may stop the charge/discharge test by performing an emergency stop.

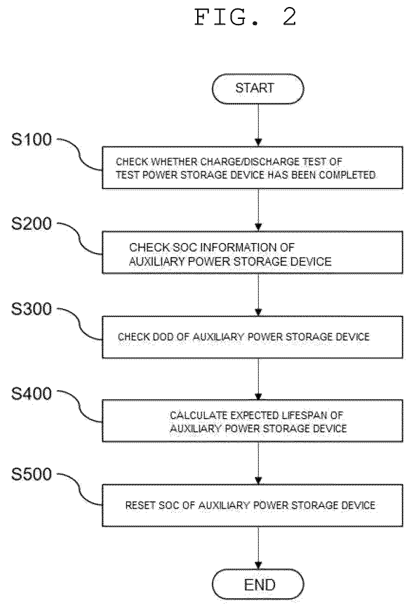

The method for resetting an SoC in a secondary battery charge/discharge test according to the present disclosure is a method for resetting the SoC of the auxiliary power storage device 200 in the system for charging and discharging a secondary battery described above. (Hereinafter, FIGS. 1 and 2 are referred to together.)

In operation S100, whether the charge/discharge test of the test power storage device 100 has been completed may be checked. Before resetting the SoC of the auxiliary power storage device 200, whether the charge/discharge test of the test power storage device 100 has been completed is first checked. If the charge/discharge test of the test power storage device 100 has been completed, the process proceeds to operation S200 below, and if the charge/discharge test has not been completed, another operation described below may be performed instead of operation S200.

If the charge/discharge test has been completed in operation S200, SoC information of the auxiliary power storage device 200 may be checked in a no-load state, unconnected to the test power storage device 100.

After the charge/discharge test of the test power storage device 100 is completed and the test power storage device 100 and the auxiliary power storage device 200 are disconnected in a no-load state, the SoC information of the auxiliary power storage device 200 may be checked.

At this time, the SoC information of the auxiliary power storage device 200 may be an SoC range of the auxiliary power storage device 200. The SoC range may be divided as 15 to 65%, 25 to 75%, 35 to 85%, 45 to 95%, 55 to 100%, and 65 to 100%. Furthermore, the SOC range may be divided to have a preset interval.

In operation S300, a depth of discharge (DOD) of the auxiliary power storage device 200 may be checked. The DoD may have a range and may be divided in a range of 50% or less or greater than 50% and 80% or less.

In operation S400, an expected lifespan of the auxiliary power storage device 200 may be calculated based on the SoC information and the DoD.

The calculated expected lifespan of the auxiliary power storage device 200 may vary depending on the SoC and DoD ranges of the auxiliary power storage device 200.

Factors affecting the expected lifespan may include temperature, pressure, SoC, and DoD. Temperature and pressure are affected by the SoC and DoD, while only the SoC and DoD may be controlled.

The expected lifespan is affected by chemical degradation. As the temperature increases, the lifespan may decrease, so that the expected lifespan may increase as the temperature decreases. The expected lifespan for such a chemical degradation reflects characteristics of a material and a formula exists, which, however, is not a controllable factor during charge and discharge and thus is not considered here.

The expected lifespan based on SoC is also affected by a chemical degradation, and degradation may become severe in a certain SoC. Generally, degradation may be greater at higher SoC.

A lifespan degradation of the expected lifespan according to the DoD may vary depending on the range of DoD due to the characteristics of the SoC described above. The DoD and SoC are in a relationship that, for the same DoD, the expected lifespan may vary depending on the range of SoC, and even for the same DoD, expected lifespan may vary depending on the range of SoC. Furthermore, different DoDs may be affected by the range of SoC and the size of the DoD. Generally, higher DoDs may lead to worse expected lifespan. Furthermore, when start SoCs are different, the range of SoC and DoD may collectively affect expected lifespan.

Considering these controllable DoD and SoC, the expected lifespan may be calculated as follows:

When the SoC range is 15 to 65% and the DoD is 50% or less, the expected lifespan may be calculated as 14.5 years. When the SoC range is 25 to 75% and the DoD is 50% or less, the expected lifespan may be calculated as 15 years. When the SoC range is 35 to 85% and the DoD is 50% or less, the expected lifespan may be calculated as 14 years. When the SoC range is 45 to 95% and the DoD is 50% or less, the expected lifespan may be calculated as 13 years. When the SoC range is 55 to 100% and the DoD is 50% or less, the expected lifespan may be calculated as 12.5 years. When the SoC range is 65 to 100% and the DoD is 50% or less, the expected lifespan may be calculated as 12.5 years.

Also, when the SoC range is 0 to 85% and the DoD is more than 50% and 80% or less, the expected lifespan may be calculated as 8.5 years. When the SoC range is 10 to 90% and the DoD is more than 50% and 80% or less, the expected lifespan may be calculated as 9 years. When the SoC range is 20 to 100% and the DoD is more than 50% and 80% or less, the expected lifespan may be calculated as 8 years. When the SoC range is 30 to 100% and the DoD is more than 50% and 80% or less, the expected lifespan may be calculated as 8 years. When the SoC range is 40 to 100% and the DoD is more than 50% and 80% or less, the expected lifespan may be calculated as 8 years. If the SoC range is 50 to 100% and the DoD is greater than 50% and 80% or less, the expected lifespan may be calculated as 8 years.

In operation S500, the start SoC of the auxiliary power storage device 200 may be reset based on the calculated expected lifespan.

When the SoC range is 15 to 65% and the DoD is 50% or less, resulting in the expected lifespan calculated as 14.5 years, the start SoC may be reset to 40%. When the SoC range is 25 to 75% and the DoD is 50% or less, resulting in the expected lifespan calculated as 15 years, the start SoC may be reset to 50%. When the SoC range is 35 to 85% and the DoD is 50% or less, resulting in the expected lifespan calculated as 14 years, the start SoC may be reset to 60%. When the SoC range is 45 to 95% and the DoD is 50% or less, resulting in the expected lifespan calculated as 13 years, the start SoC may be reset to 70%. When the SoC range is 55 to 100% and the DoD is 50% or less, resulting in the expected lifespan calculated as 12.5 years, the start SoC may be reset to 80%. When the SoC range is 65 to 100% and the DoD is 50% or less, resulting in the expected lifespan calculated as 12.5 years, the start SoC may be reset to 90%.

Furthermore, when the SoC range is 0 to 80% and the DoD is greater than 50% and 80% or less, resulting in the expected lifespan calculated as 8.5 years, the start SoC may be reset to 40%. When the SoC range is 10 to 90% and the DoD is greater than 50% and 80% or less, resulting in the expected lifespan calculated as 9 years, the start SoC may be reset to 50%. When the SoC range is 20 to 100% and the DoD is greater than 50% and 80% or less, resulting in the expected lifespan calculated as 8 years, the start SoC may be reset to 60%. When the SoC range is 30 to 100% and the DoD is greater than 50% and 80% or less, resulting in the expected lifespan calculated as 8 years, the start SoC may be reset to 70%. When the SoC range is 40 to 100% and the DoD is greater than 50% and 80% or less, resulting in the expected lifespan calculated as 8 years, the start SoC may be reset to 80%. When the SoC range is 50 to 100% and the DoD is greater than 50% and 80% or less, resulting in the expected lifespan calculated as 8 years, the start SoC may be reset to 90%.

Here, the start SoC of the auxiliary power storage device 200 may be reset to the maximum expected lifespan within the calculated expected lifespan.

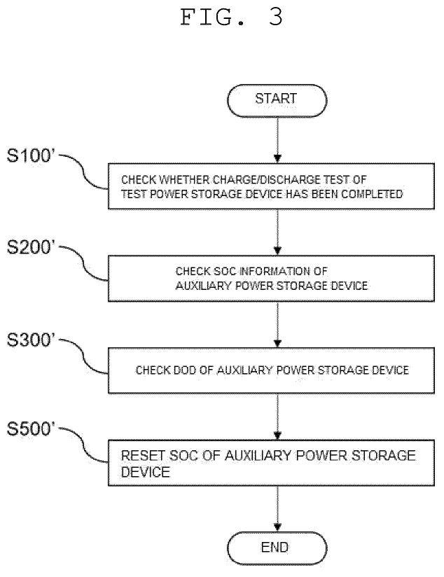

In the method of resetting an SoC in a secondary battery charge/discharge test, a state of connection between the test power storage device 100 and the auxiliary power storage device 200 is described. (Hereinafter, FIGS. 1 and 3 are referred to together.) In operation S100′, whether the charge/discharge test of the test power storage device 100 has been completed may be checked. Before resetting the SoC of the auxiliary power storage device 200, whether the charge/discharge test of the test power storage device 100 has been completed is first checked.

In operation S200′, if the charge/discharge test has not been completed, the SoC information of the auxiliary power storage device 200 may be checked while the auxiliary power storage device 200 is connected to the test power storage device 100. The SoC information may be an SoC range of the auxiliary power storage device 200. The SoC range may range from 0 to 100%.

In operation S300′, the DoD of the auxiliary power storage device 200 may be checked. The DoD may range from 40% or less or from more than 40% to 100% or less.

In operation S500′, the start SoC of the auxiliary power storage device 200 may be reset based on the DoD.

The start SoC of the auxiliary power storage device 200 may be reset based on the range of the DoD.

When the DoD range is 40% or less, the start SoC may be reset to 80%. When the DoD range is greater than 40% and 50% or less, the start SoC may be reset to 75%. When the DoD range is greater than 50% and 60% or less, the start SoC may be reset to 70%. When the DoD range is greater than 60% and 70% or less, the start SoC may be reset to 65%. When the DoD range is greater than 70% and 80% or less, the start SoC may be reset to 60%. When the DoD range is greater than 80% and 90% or less, the start SoC may be reset to 55%. When the DoD range is greater than 90% and 100% or less, the start SoC may be reset to 50%.

In addition, in the method of resetting a SoC in a secondary battery charge/discharge test according to the present disclosure, when the SoC of the test power storage device 100 is a fully charged state before the charge/discharge test, the controller 300 may externally transfer power from the test power storage device 100.

There may be cases that the SoC of the test power storage device 100 is a fully charged state before the charge/discharge test, and the test power storage device 100 may be discharged to use power to charge the auxiliary power storage device 200. However, if the SoC of the auxiliary power storage device 200 is sufficiently high, the power may not be used to charge the auxiliary power storage device 200. In such cases, the power from the test power storage device 100 may be externally transferred.

In such cases, the power from the test power storage device 100 may be transferred using a DC/AC converter. DC voltage of the test power storage device 100 may be converted into AC voltage using the DC/AC converter and used for an external source.

Here, the external source may be used for devices excluding the auxiliary power storage device and the test power storage device, such as a controller, etc., including the DC/AC converter.

According to the present disclosure, in a secondary battery charge/discharge test, the expected lifespan is calculated based on the DoD and SoC of the auxiliary power storage device within a range and the auxiliary power storage device is changed to a start SoC with a higher expected lifespan based on the calculated expected lifespan, thereby extending the lifespan of the auxiliary power storage device.

The above descriptions are merely an example of applying the principles of the present disclosure, and other components may be included without departing from the scope of the present disclosure.

### DETAILED DESCRIPTION OF MAIN ELEMENTS

100: Test power storage device
200: Auxiliary power storage device
300: Controller

What is claimed is:

1. A method of resetting a state of charge (SoC) in a secondary battery charge/discharge test, as a method of resetting an SoC of an auxiliary power storage device in a secondary battery charge/discharge test, in which a test power storage device including a plurality of test secondary batteries is connected to a separate auxiliary power storage device and a controller controls charging and discharging of the test power storage device and the auxiliary power storage device to perform a charge/discharge test of the test power storage device, the method comprising:
checking whether the charge/discharge test of the test power storage device has been completed;
checking SoC information of the auxiliary power storage device in a no-load state unconnected to the test power storage device, when the charge/discharge test has been completed;
checking a depth of discharge (DoD) of the auxiliary power storage device;
calculating an expected lifespan of the auxiliary power storage device based on the SoC information and the DoD; and
resetting a start SoC of the auxiliary power storage device based on the calculated expected lifespan.

2. The method of claim 1, wherein, in the checking of the SoC information of the auxiliary power storage device, the SoC information is an SoC range of the auxiliary power storage device.

3. The method of claim 2, wherein the SoC range is between 15% and 100% but is divided by set intervals.

4. The method of claim 1, wherein, in the checking of the DoD, the DoD has a range of 50% or less or more than 50% and 80% or less.

5. The method of claim 1, wherein, in the resetting of the start SoC of the auxiliary power storage device, the start SoC of the auxiliary power storage device is reset to a maximum expected lifespan in the calculated expected lifespan.

6. The method of claim 1, wherein, when the SoC of the test power storage device is a fully charged state before the charge/discharge test, the controller externally transfers power of the test power storage device.

7. A method of resetting a state of charge (SoC) in a secondary battery charge/discharge test, as a method of resetting an SoC of an auxiliary power storage device in a secondary battery charge/discharge test, in which a test power storage device including a plurality of test secondary batteries is connected to a separate auxiliary power storage device and a controller controls charging and discharging of the test power storage device and the auxiliary power storage device to perform a charge/discharge test of the test power storage device, the method comprising:
checking whether the charge/discharge test of the test power storage device has been completed;
checking SoC information of the auxiliary power storage device in a state of being connected to the test power storage device when the charge/discharge test has not been completed;
checking a depth of discharge (DoD) of the auxiliary power storage device; and
resetting a start SoC of the auxiliary power storage device based on the DoD.

8. The method of claim 7, wherein, in the checking of the DoD of the auxiliary power storage device, the DoD has a range of 40% or less or more than 40% and 100% or less.

9. The method of claim 7, wherein, in the resetting of the start SoC of the auxiliary power storage device, the start SoC of the auxiliary power storage device is reset based on the range of the DoD.

10. The method of claim 7, wherein, when the SoC of the test power storage device is a fully charged state before the charge/discharge test, the controller externally transfers power of the test power storage device.
